(19) United States
(12) Patent Application Publication
(10) Pub. No.: US 2006/0139017 A1
(43) Pub. Date: Jun. 29, 2006

(54) Interface circuit for electronic test system

(76) Inventors: Ronald J. Peiffer, Loveland, CO (US); Robert E. McAuliffe, Loveland, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/024,120

(22) Filed: Dec. 28, 2004

(51) Int. Cl. G05F 1/40; G05F 1/618

(52) U.S. Cl. 323/282

(57) ABSTRACT

An electronic interface circuit. The electronic interface circuit includes a stimulus circuit which further includes a first voltage source, a driver circuit having first and second driver outputs, a first switch having first-switch input, first-switch output, and first-switch control input, a first filter having first-filter input and first-filter output, a second switch having second-switch input, second-switch output, and second-switch control input, and a second filter having second-filter input and second-filter output. The output of the first voltage source is connected to the first-switch input; the first driver output is connected to the first-switch control input; the first-switch output is connected to the first-filter input; the second-switch input is connected to a reference potential; the second driver output is connected to the second-switch control input; the second-switch output is connected to the second-filter input; and the first-filter output is connected to the second-filter output.

### BACKGROUND

Printed circuit boards provide a practical and economical means for the interconnection of large numbers of electronic devices. The demand for increased functionality has led to the development of integrated circuits and other components having greater speeds and functionalities, along with an increase in printed circuit board component densities.

This increase in printed circuit board component densities and operational speeds has placed increased demands on their testing. During the development and manufacture of these electronic circuits, it is necessary to perform various tests to confirm design concept, as well as to verify functionality of the manufactured parts. In order to perform such tests in a reasonable time at an affordable cost, test systems dedicated to such purposes have been developed.

These test systems are referred to as ATE (automatic text equipment) systems. The term Automatic Test Equipment refers to the test hardware and its accompanying software. The ATE system is typically controlled by a computer which is used to control various electronic test instruments such as digital voltmeters, waveform analyzers, signal generators, switching assemblies, and the like. This equipment typically operates under control of specially designed test software which operates on the computer and which can provide stimuli to various parts of the printed circuit board. The various stimuli which the printed circuit board could be expected to experience during its normal operation can be applied and the response of the board to these stimuli observed. The results of the test can then be compared with that which would be expected in order to determine whether or not the board meets the specification for the particular test performed.

Typically the interface between the ATE computer with the various electronic test instruments that it controls and the printed circuit board being tested is a test head. The test head includes a number of probes for electrical connection to the various test points on the printed circuit board, driver electronics, and relays for switching the electronics between the various probes. The test head electronics is referred to as pin electronics and forms basically a buffer between the main part of the test system and the printed circuit board being tested. The need to test printed circuit boards at high frequencies has dictated that this buffering be as close to the board as possible, i.e., on the test head. However, space considerations on the test head, as well as cost, have necessitated the multiplexing of test head electronics between the various test probes of the test head. Multiplexing has added a degree of complexity to the software programs controlling the testing.

### SUMMARY

In a representative embodiment, an electronic interface circuit comprises a stimulus circuit which further comprises a first voltage source, a driver circuit having a first and a second driver outputs, a first switch having a first-switch input, a first-switch output, and a first-switch control input, a first filter having a first-filter input and a first-filter output, a second switch having a second-switch input, a second-switch output, and a second-switch control input, and a second filter having a second-filter input and a second-filter output. The output of the first voltage source is connected to the first-switch input; the first driver output is connected to the first-switch control input; the first-switch output is connected to the first-filter input; the second-switch input is connected to a reference potential; the second driver output is connected to the second-switch control input; the second-switch output is connected to the second-filter input; and the first-filter output is connected to the second-filter output.

In another representative embodiment, an electronic interface circuit, comprises a stimulus circuit which further comprises a first voltage source, a second voltage source, a driver circuit having a first and a second driver outputs, a first switch having a first-switch input, a first-switch output, and a first-switch control input, a first filter having a first-filter input and a first-filter output, a second switch having a second-switch input, a second-switch output, and a second-switch control input, and a second filter having a second-filter input and a second-filter output. The output of first voltage source is connected to the first-switch input; the first driver output is connected to the first-switch control input; the first-switch output is connected to the first-filter input; the output of second voltage source is connected to the second-switch input; the second driver output is connected to the second-switch control input; the second-switch output is connected to the second-filter input; and the first-filter output is connected to the second-filter output.

Other aspects and advantages of the representative embodiments presented herein will become apparent from the following detailed description, taken in conjunction with the accompanying drawings.

### BRIEF DESCRIPTION OF THE DRAWINGS

The accompanying drawings provide visual representations which will be used to more fully describe various representative embodiments and can be used by those skilled in the art to better understand them and their inherent advantages. In these drawings, like reference numerals identify corresponding elements.

FIG. 1 is a drawing of an electronic test system as described in various representative embodiments.

FIG. 2 is another drawing of the electronic test system of FIG. 1.

FIG. 3 is a drawing of a diagram of the electronic interface circuit as described in various representative embodiments.

FIG. 4 is a drawing of a diagram of another electronic interface circuit as described in various representative embodiments.

FIG. 5 is a drawing of a diagram of yet another electronic interface circuit as described in various representative embodiments.

FIG. 6 is a drawing of a diagram of still another electronic interface circuit as described in various representative embodiments.

### DETAILED DESCRIPTION

As shown in the drawings for purposes of illustration, the present patent document discloses novel techniques for the implementation of pin electronics that are inexpensive, power efficient, and require only a small area of the test head printed circuit board to implement. The components used can be standard, off the shelf devices. The resulting solution enables the construction of an overdriving, non-multiplexed, printed circuit board test system at a cost competitive with existing multiplexed test systems. Previous solutions, which were capable of testing printed circuit boards having comparable component densities at comparable speeds, typically required multiplexing the test head electronics to obtain the needed performance or sacrificed overdriving performance in order to increase the number of test channels.

In the following detailed description and in the several figures of the drawings, like elements are identified with like reference numerals.

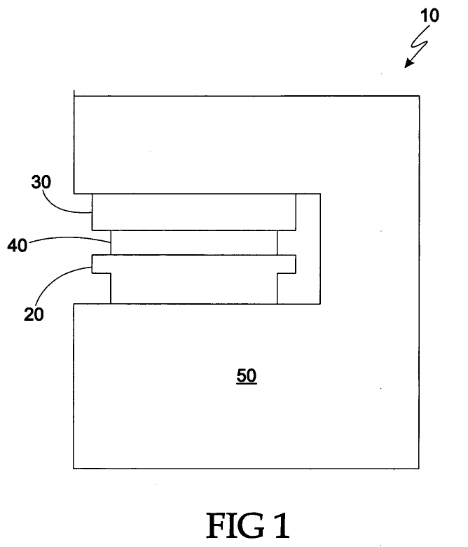

FIG. 1 is a drawing of an electronic test system 10 as described in various representative embodiments. In FIG. 1, the electronic test system 10, also referred to herein as test system 10, comprises a base 20 and a test head 30, as well as any electronics and other mechanical components necessary to test and discharge a device under test 40. Other items necessary for test performance, such as a computer, computer software/firmware, other electronic circuits/devices/interconnects, and the like, will typically be included in or adjacent to supporting structure 50. In the representative embodiment of FIG. 1, the base 20 is capable of downward retraction which permits insertion of the device under test 40 between the base 20 and the test head 30. Upward extension of the base forces the device under test 40 into electrical contact with the test head 30 via appropriately placed test pins on the test head 30 and the device under test 40, in which position circuits and devices on the device under test 40 can be tested.

It will be recognized by one of ordinary skill in the art that the device under test 40 could be a loaded or bare printed circuit board, a packaged integrated circuit or other electronic device, an integrated circuit in die form on a semiconductor wafer, or the like.

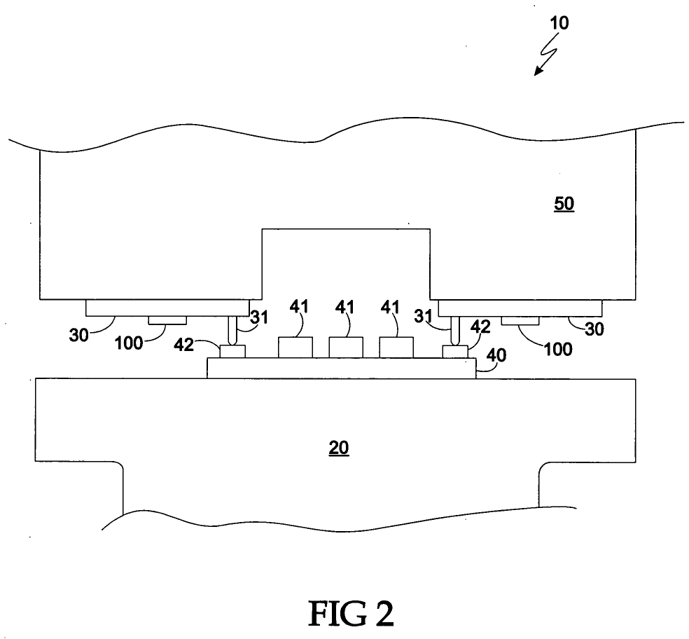

FIG. 2 is another drawing of the electronic test system 10 of FIG. 1. In FIG. 2, the device under test 40 rests on top of the base 20. The device under test 40 is shown as a printed circuit board 40 comprising various components 41 and connecting pads 42. Connecting pads 42 are electrically interconnected to components 41 by means of metal traces and vias on the printed circuit board 40 under test. Connecting pads 42 are used for applying power, applying test stimuli, detecting responses to test stimuli, and operationally interconnecting to components external to the printed circuit board 40 in applications for which the printed circuit board 40 was designed. During a test of the printed circuit board 40, the base 20 is raised until test pins 31 on the test head 30 come into contact with connecting pads 42 on the printed circuit board 40. Test head 30 is also typically a printed circuit board designed and fabricated as an interface between the electronics of the test system 10 and the device under test 40. Test head 30 comprises an electronic interface circuit 100 designed to interface stimuli signals from the electronics of the test system 10 to the device under test 40 and to detect response signals from the device under test 40. The electronic interface circuit 100 receives test signals from the electronics of the test system 10 and transfers them to the device under test 40. The electronic interface circuit 100 also receives response signals from the device under test 40 and transfers them to the electronics of the test system 10 for comparison and analysis. The test head 30 interconnects electronically to the electronics of the test system 10 via connections to the supporting structure 50. These connections between the test head 30 and the electronics of the test system 10 are not specifically shown in the drawings.

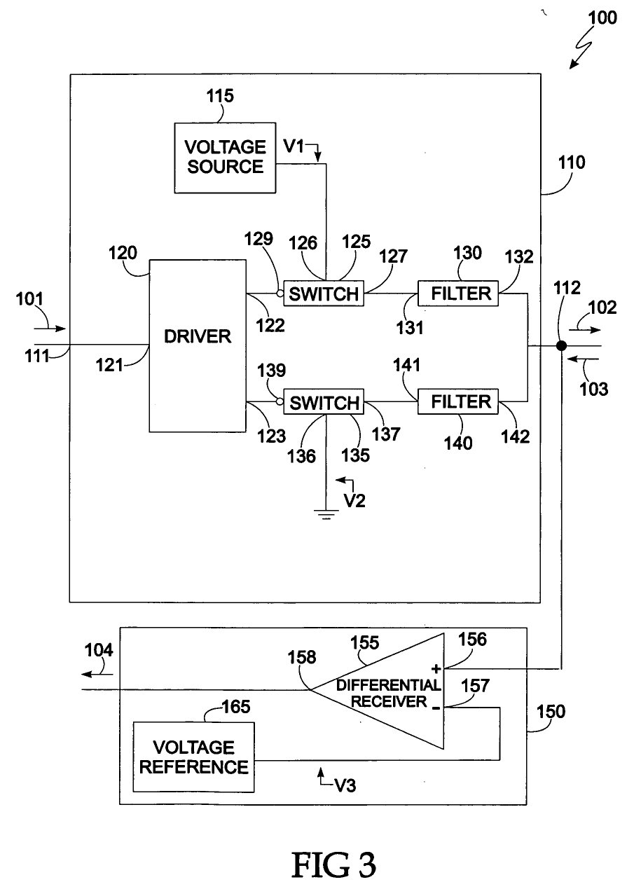

FIG. 3 is a drawing of a diagram of the electronic interface circuit 100 as described in various representative embodiments. In FIG. 3, the electronic interface circuit 100 comprises a stimulus circuit 110 and a detection circuit 150. The stimulus circuit receives a drive signal 101 at stimulus-circuit input 111 and transforms the drive signal 101 into test stimulus signal 102 at stimulus-circuit output 112. In a representative embodiment, stimulus-circuit output 112 is connected to one of the test pins 31 on the test head 30 shown in FIG. 2.

As shown in the representative embodiment of FIG. 3, the stimulus circuit 110 comprises a first voltage source 115, a driver circuit 120, a first switch 125, a first filter 130, a second switch 135, and a second filter 140. The driver circuit 120 has a driver input 121 and a first and a second driver outputs 122,123; the first switch 125 has a first-switch input 126, a first-switch output 127, and a first-switch control input 129; the first filter 130 has a first-filter input 131 and a first-filter output 132; the second switch 135 has a second-switch input 136, a second-switch output 137, and a second-switch control input 139; and the second filter 140 has a second-filter input 141 and a second-filter output 142. In representative embodiments, the driver circuit 120 also comprises a tri-state input, as well as the data input referred to herein as the driver input 121.

The output of first voltage source 115 which is at first drive voltage V1 is connected to the first-switch input 126; the first driver output 122 is connected to the first-switch control input 129; the first-switch output 127 is connected to the first-filter input 131; the second-switch input 136 is connected to a reference potential V2, also referred to herein as a second drive voltage V2, which in the representative embodiment of FIG. 3 is ground potential V2; the second driver output 123 is connected to the second-switch control input 139; the second-switch output 137 is connected to the second-filter input 141; and the first-filter output 132 is connected to the second-filter output 142.

The electronic interface circuit 100 further comprises the detection circuit 150, wherein the detection circuit 150 comprises a differential receiver 155, also referred to herein as a receiver 155, and a third voltage reference 165, also referred to herein as a detection voltage reference 165. The differential receiver 155 has a first receiver input 156, a second receiver input 157, and a receiver output 158. The first receiver input 156 is connected to first-filter output 132 and to the second-filter output 142, and the second receiver input 157 is connected to output of the detection voltage reference 165 which is at comparison voltage V3. The receiver output 158 can be connected to the test system 10 electronics for the collection, comparison, and/or analysis of the test stimulus signal 102 at the stimulus-circuit output 112 or a response signal 103 received from the device under test 40 due to the test stimulus signal 102 received by the device under test 40 at another test pin 31 on the test head 30. In response to the response signal 103, the differential receiver 155 outputs a response output signal 104 at the receiver output 158.

In operation, a test signal indicated in FIG. 3 as drive signal 101 is applied to the stimulus circuit 110 at stimulus-circuit input 111 which is electrically the same as the driver input 121. In response to the drive signal 101, the driver circuit 120 turns on either the first switch 125 via a signal at the first-switch control input 129, or the driver circuit 120 turns on the second switch 135 via a signal at the second-switch control input 139. If neither first switch 125 nor second switch 135 is turned on, the stimulus circuit 110 is in a high impedance state (tri-state).

If the first switch 125 is turned on and the second switch 135 is turned off, the output of the first voltage source 115 is electrically connected to the first-switch output 127 which results in the potential of the output of the first voltage source 115 less any voltage drop across the first switch 125 appearing at the first-switch output 127. Again, the potential of the output of the first voltage source 115 is identified in FIG. 3 as first drive voltage V1. The first filter 130 filters the high-frequency components of the voltage waveform appearing at the first-switch output 127 to reduce/remove any ringing that might be present due to the switching on and off of the first switch 125. This filtered signal appears at the first-filter output 132 as test stimulus signal 102. The test stimulus signal 102 is then available for application to the device under test 40 via one of the test pins 31.

If the second switch 135 is turned on and the first switch 125 is turned off, the reference potential V2 (less any voltage drop across the second switch 135) is connected to the second-switch output 137. The reference potential V2 is at ground potential V2 in the representative embodiment of FIG. 3. The second filter 140 filters the high-frequency components of the voltage waveform appearing at the second-switch output 137 to reduce/remove any ringing that might be present due to the switching on and off of the second switch 135. This filtered signal appears at the second-filter output 142 as test stimulus signal 102. The test stimulus signal 102 is then available for application to the device under test 40 via one of the test pins 31.

If neither first switch 125 nor second switch 135 is turned on, the stimulus-circuit output 112 is in a high-impedance state (tri-state). In this condition the stimulus circuit 110 presents a minimal load to the device under test 40.

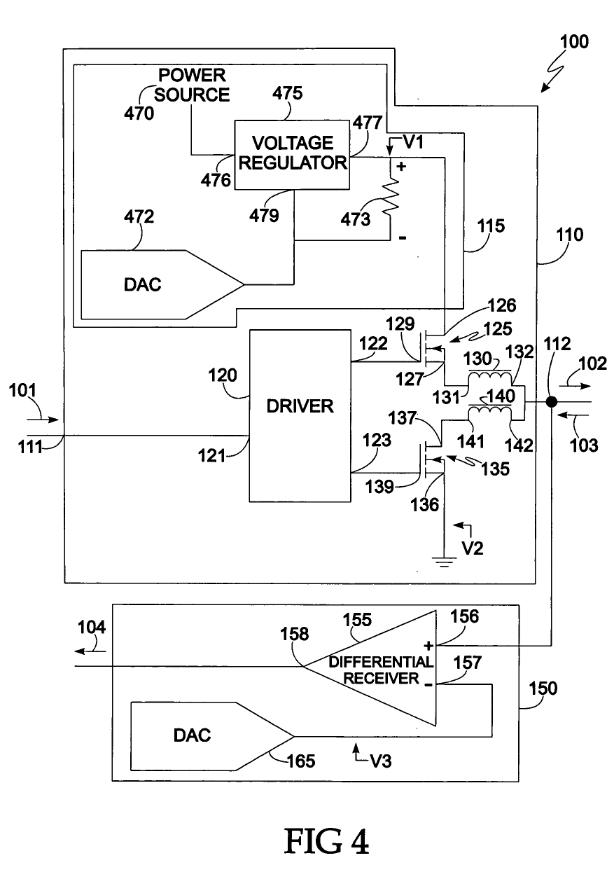

FIG. 4 is a drawing of a diagram of another electronic interface circuit 100 as described in various representative embodiments. In FIG. 4, the electronic interface circuit 100 comprises the stimulus circuit 110 and the detection circuit 150. As in FIG. 3, the stimulus circuit 110 receives the drive signal 101 at stimulus-circuit input 111 and transforms the drive signal 101 into test stimulus signal 102 at stimulus-circuit output 112. In a representative embodiment, stimulus-circuit output 112 is connected to one of the test pins 31 on the test head 30 shown in FIG. 2.

As shown in the representative embodiment of FIG. 4, the stimulus circuit 110 comprises the first voltage source 115, the driver circuit 120, the first switch 125, the first filter 130, the second switch 135, and the second filter 140. In FIG. 4, the first switch 125 is shown as first field effect transistor 125, which could be an n-channel metal-oxide-semiconductor (MOS) field effect transistor (FET) as shown in FIG. 4, a p-channel metal-oxide-semiconductor field effect transistor, or the like; the second switch 135 is shown as second field effect transistor 135, which could be an n-channel metal-oxide-semiconductor field effect transistor, a p-channel metal-oxide-semiconductor field effect transistor, or the like; the first filter 130 is shown as first ferrite bead 130; and the second filter 140 is shown as second ferrite bead 140.

In FIG. 4, the first-switch input 126 is shown as the drain of the first field effect transistor 125, wherein the first field effect transistor 125 is depicted as an n-channel metal-oxide-semiconductor field effect transistor; the first-switch output 127 is shown as the source of the n-channel metal-oxide-semiconductor field effect transistor; and the first-switch control input 129 is shown as the gate of the n-channel metal-oxide-semiconductor field effect transistor.

The second-switch input 136 is shown as the source of the second field effect transistor 135, wherein the second field effect transistor 135 is depicted as an n-channel metal-oxide-semiconductor field effect transistor; the second-switch output 137 is shown as the drain of the n-channel metal-oxide-semiconductor field effect transistor; and the second-switch control input 139 is shown as the gate of the n-channel metal-oxide-semiconductor field effect transistor.

Also in FIG. 4, the first-filter input 131 is shown as one of the contacts of the first ferrite bead 130; the first-filter output 132 is shown as the other contact of the first ferrite bead 130; the second-filter input 141 is shown as one of the contacts of the second ferrite bead 140; and the second-filter output 142 is shown as the other contact of the second ferrite bead 140.

Further in FIG. 4, the first voltage source 115 comprises a first electrical power source 470, also referred to herein as a first power source 470, a first voltage reference 472, a first voltage regulator 475, and a first feedback resistor 473. The first voltage reference 472 could be a digital to analogue converter (DAC) with its input set appropriately or the like. The first voltage regulator 475 has a first-voltage regulator input 476, a first-voltage regulator output 477, and first-voltage regulator control input 479. In the representative embodiment of FIG. 4, first drive voltage V1 is obtained by applying electrical power from the first power source 470 to the first voltage regulator 475 at the first-voltage regulator input 476. The output of the first voltage reference 472 is applied to the first voltage regulator 475 at the first-voltage regulator control input 479 to set the value of the first drive voltage V1 at output of the first voltage source 115 which is connected to the first-switch input 126 of the first switch 125. Circuit feedback is provided by connecting first feedback resistor 473 between the first-voltage regulator output 477 and the first-voltage regulator control input 479.

The driver circuit 120 has driver input 121 and first and second driver outputs 122,123.

The output of the first voltage source 115 which is at first drive voltage V1 is connected to the first-switch input 126; the first driver output 122 is connected to the first-switch control input 129; the first-switch output 127 is connected to the first-filter input 131; the second-switch input 136 is connected to the reference potential V2 which in the representative embodiment of FIG. 4 is ground potential V2; the second driver output 123 is connected to the second-switch control input 139; the second-switch output 137 is connected to the second-filter input 141; and the first-filter output 132 is connected to the second-filter output 142.

The electronic interface circuit 100 further comprises the detection circuit 150, wherein the detection circuit 150 comprises the differential receiver 155, and the detection voltage reference 165. The differential receiver 155 has the first receiver input 156, the second receiver input 157, and the receiver output 158. The first receiver input 156 is connected to first-filter output 132 and to the second-filter output 142, and the second receiver input 157 is connected to output of the detection voltage reference 165 which is at comparison voltage V3. The detection voltage reference 165 could be a digital to analogue converter (DAC) with its input set appropriately or the like. The receiver output 158 can be connected to the test system 10 electronics for the collection, comparison, and/or analysis of the test stimulus signal 102 at the stimulus-circuit output 112 or a response signal 103 received from the device under test 40 due to the test stimulus signal 102 received by the device under test 40 at another test pin 31 on the test head 30. In response to the response signal 103, the differential receiver 155 outputs a response output signal 104 at the receiver output 158.

In operation, a test signal indicated in FIG. 4 as drive signal 101 is applied to the stimulus circuit 110 at stimulus-circuit input 111 which is electrically the same as the driver input 121. In response to the drive signal 101, the driver circuit 120 turns on either the first field effect transistor 125 via a signal at the first-switch control input 129, or the driver circuit 120 turns on the second field effect transistor 135 via a signal at the second-switch control input 139.

If the first field effect transistor 125 is turned on and the second field effect transistor 135 is turned off, the output of the first voltage source 115 is electrically connected to the first-switch output 127 which results in the potential of the output of the first voltage source 115 less any voltage drop across the first field effect transistor 125 appearing at the first-switch output 127. Again, the potential of the output of the first voltage source 115 is identified in FIG. 4 as first drive voltage V1. The first filter 130 filters the high-frequency components of the voltage waveform appearing at the first-switch output 127 to reduce/remove any ringing that might be present due to the switching on and off of the first field effect transistor 125. This filtered signal appears at the first-filter output 132 as test stimulus signal 102. The test stimulus signal 102 is then available for application to the device under test 40 via one of the test pins 31.

If the second field effect transistor 135 is turned on and the first field effect transistor 125 is turned off, the reference potential V2 (less any voltage drop across the second field effect transistor 135) is connected to the second-switch output 137 (the drain of the MOSFET). The reference potential V2 is at ground potential V2 in the representative embodiment of FIG. 4. The second filter 140 filters the high-frequency components of the voltage waveform appearing at the second-switch output 137 to reduce/remove any ringing that might be present due to the switching on and off of the second switch 135. This filtered signal appears at the second-filter output 142 as test stimulus signal 102. The test stimulus signal 102 is then available for application to the device under test 40 via one of the test pins 31.

If neither first field effect transistor 125 nor second field effect transistor 135 is turned on, the stimulus-circuit output 112 is in a high-impedance state (tri-state). In this condition the stimulus circuit 110 presents a minimal load to the device under test 40.

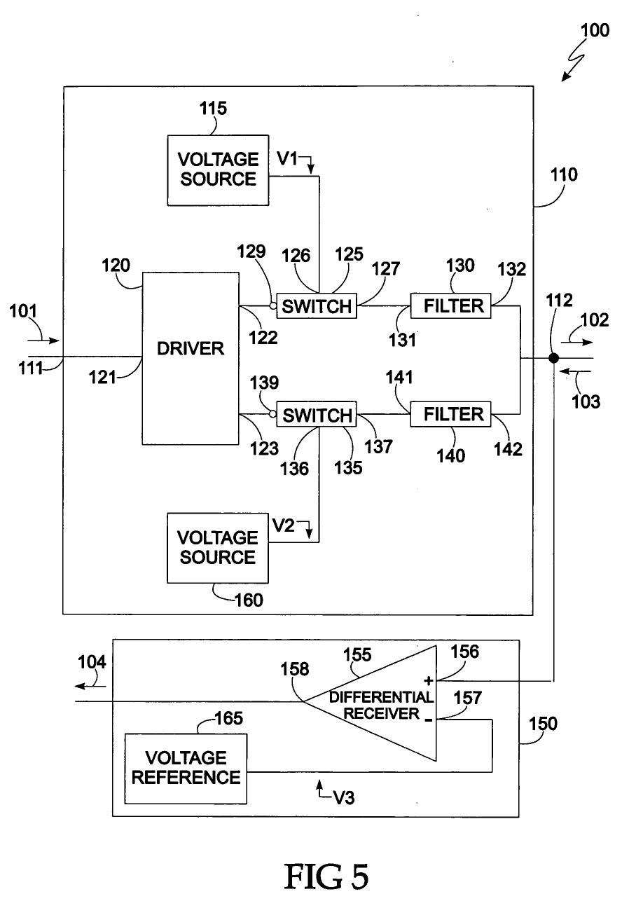

FIG. 5 is a drawing of a diagram of yet another electronic interface circuit 100 as described in various representative embodiments. In FIG. 5, the electronic interface circuit 100 comprises a stimulus circuit 110 and a detection circuit 150. The stimulus circuit receives a drive signal 101 at stimulus-circuit input 111 and transforms the drive signal 101 into test stimulus signal 102 at stimulus-circuit output 112. In a representative embodiment, stimulus-circuit output 112 is connected to one of the test pins 31 on the test head 30 shown in FIG. 2.

As shown in the representative embodiment of FIG. 5, the stimulus circuit 110 comprises a first voltage source 115, a driver circuit 120, a first switch 125, a first filter 130, a second switch 135, a second filter 140, and a second voltage source 160. The driver circuit 120 has a driver input 121 and a first and a second driver outputs 122,123; the first switch 125 has a first-switch input 126, a first-switch output 127, and a first-switch control input 129; the first filter 130 has a first-filter input 131 and a first-filter output 132; the second switch 135 has a second-switch input 136, a second-switch output 137, and a second-switch control input 139; and the second filter 140 has a second-filter input 141 and a second-filter output 142.

The output of first voltage source 115 which is at first drive voltage V1 is connected to the first-switch input 126; the first driver output 122 is connected to the first-switch control input 129; the first-switch output 127 is connected to the first-filter input 131; the output of second voltage source 160 which is at second drive voltage V2 is connected to the second-switch input 136; the second driver output 123 is connected to the second-switch control input 139; the second-switch output 137 is connected to the second-filter input 141; and the first-filter output 132 is connected to the second-filter output 142.

The electronic interface circuit 100 further comprises the detection circuit 150, wherein the detection circuit 150 comprises a differential receiver 155 and a detection voltage reference 165. The differential receiver 155 has a first receiver input 156, a second receiver input 157, and a receiver output 158. The first receiver input 156 is connected to first-filter output 132 and to the second-filter output 142, and the second receiver input 157 is connected to output of the detection voltage reference 165 which is at comparison voltage V3. The receiver output 158 can be connected to the test system 10 electronics for the collection, comparison, and/or analysis of the test stimulus signal 102 at the stimulus-circuit output 112 or a response signal 103 received from the device under test 40 due to the test stimulus signal 102 received by the device under test 40 at another test pin 31 on the test head 30. In response to the response signal 103, the differential receiver 155 outputs a response output signal 104 at the receiver output 158.

In operation, a test signal indicated in FIG. 5 as drive signal 101 is applied to the stimulus circuit 110 at stimulus-circuit input 111 which is electrically the same as the driver input 121. In response to the drive signal 101, the driver circuit 120 turns on either the first switch 125 via a signal at the first-switch control input 129, or the driver circuit 120 turns on the second switch 135 via a signal at the second-switch control input 139.

If the first switch 125 is turned on and the second switch 135 is turned off, the output of the first voltage source 115 is electrically connected to the first-switch output 127 which results in the potential of the output of the first voltage source 115 less any voltage drop across the first switch 125 appearing at the first-switch output 127. Again, the potential of the output of the first voltage source 115 is identified in FIG. 5 as first drive voltage V1. The first filter 130 filters the high-frequency components of the voltage waveform appearing at the first-switch output 127 to reduce/remove any ringing that might be present due to the switching on and off of the first switch 125. This filtered signal appears at the first-filter output 132 as test stimulus signal 102. The test stimulus signal 102 is then available for application to the device under test 40 via one of the test pins 31.

If the second switch 135 is turned on and the first switch 125 is turned off, a second drive voltage V2 less any voltage drop across the second switch 135 is connected to the second-switch output 137. The second filter 140 filters the high-frequency components of the voltage waveform appearing at the second-switch output 137 to reduce/remove any ringing that might be present due to the switching on and off of the second switch 135. This filtered signal appears at the second-filter output 142 as test stimulus signal 102. The test stimulus signal 102 is then available for application to the device under test 40 via one of the test pins 31.

If neither first switch 125 nor second switch 135 is turned on, the stimulus-circuit output 112 is in a high-impedance state (tri-state). In this condition, the stimulus circuit 110 presents a minimal load to the device under test 40.

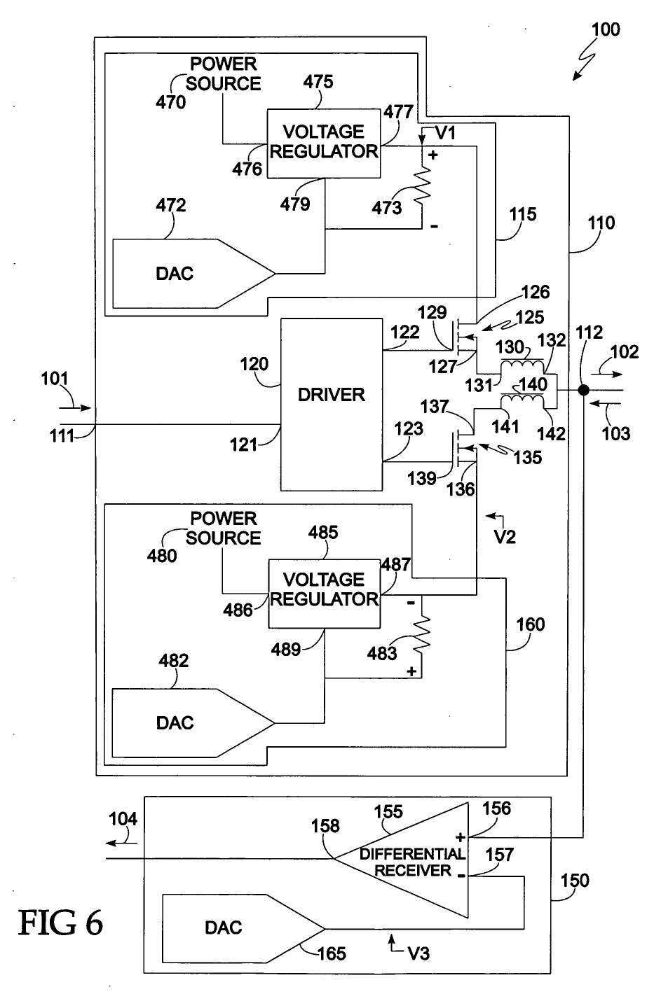

FIG. 6 is a drawing of a diagram of still another electronic interface circuit 100 as described in various representative embodiments. In FIG. 6, the electronic interface circuit 100 comprises the stimulus circuit 110 and the detection circuit 150. As in FIG. 5, the stimulus circuit 110 receives the drive signal 101 at stimulus-circuit input 111 and transforms the drive signal 101 into test stimulus signal 102 at stimulus-circuit output 112. In a representative embodiment, stimulus-circuit output 112 is connected to one of the test pins 31 on the test head 30 shown in FIG. 2.

As shown in the representative embodiment of FIG. 6, the stimulus circuit 110 comprises the first voltage source 115, the driver circuit 120, the first switch 125, the first filter 130, the second switch 135, the second filter 140, and the second voltage source 160. In FIG. 6, the first switch 125 is shown as first field effect transistor 125, which could be an n-channel metal-oxide-semiconductor field effect transistor as shown in FIG. 6, a p-channel metal-oxide-semiconductor field effect transistor, or the like; the second switch 135 is shown as second field effect transistor 135, which could be an n-channel metal oxide field effect transistor, a p-channel metal-oxide-semiconductor field effect transistor, or the like; the first filter 130 is shown as first ferrite bead 130; and the second filter 140 is shown as second ferrite bead 140.

In FIG. 6, the first-switch input 126 is shown as the drain of the first field effect transistor 125, wherein the first field effect transistor 125 is depicted as an n-channel metal-oxide-semiconductor field effect transistor; the first-switch output 127 is shown as the source of the n-channel metal-oxide-semiconductor field effect transistor; and the first-switch control input 129 is shown as the gate of the n-channel metal-oxide-semiconductor field effect transistor.

The second-switch input 136 is shown as the source of the second field effect transistor 135, wherein the second field effect transistor 135 is depicted as an n-channel metal-oxide-semiconductor field effect transistor; the second-switch input 136 is shown as the source of the n-channel metal-oxide-semiconductor field effect transistor; the second-switch output 137 is shown as the drain of the n-channel metal-oxide-semiconductor field effect transistor; and the second-switch control input 139 is shown as the gate of the n-channel metal-oxide-semiconductor field effect transistor.

Also in FIG. 6, the first-filter input 131 is shown as one of the contacts of the first ferrite bead 130; the first-filter output 132 is shown as the other contact of the first ferrite bead 130; the second-filter input 141 is shown as one of the contacts of the second ferrite bead 140; and the second-filter output 142 is shown as the other contact of the second ferrite bead 140.

Further in FIG. 6, the first voltage source 115 comprises a first power source 470, a first voltage reference 472, a first voltage regulator 475, and a first feedback resistor 473. The first voltage reference 472 could be a digital to analogue converter (DAC) with its input set appropriately or the like. The first voltage regulator 475 has a first-voltage regulator input 476, a first-voltage regulator output 477, and first-voltage regulator control input 479. In the representative embodiment of FIG. 6, first drive voltage V1 is obtained by applying electrical power from the first power source 470 to the first voltage regulator 475 at the first-voltage regulator input 476. The output of the first voltage reference 472 is applied to the first voltage regulator 475 at the first-voltage regulator control input 479 to set the value of the first drive voltage V1 at output of the first voltage source 115 which is connected to the first-switch input 126 of the first switch 125. Circuit feedback is provided by connecting first feedback resistor 473 between the first-voltage regulator output 477 and the first-voltage regulator control input 479.

The driver circuit 120 has driver input 121 and first and second driver outputs 122,123.

The second voltage source 160 comprises a second electrical power source 480, also referred to herein as a second power source 480, a second voltage reference 482, a second voltage regulator 485, and a second feedback resistor 483. The second voltage reference 482 could be a digital to analogue converter (DAC) with its input set appropriately or the like. The second voltage regulator 485 has a second-voltage regulator input 486, a second-voltage regulator output 487, and second-voltage regulator control input 489. In the representative embodiment of FIG. 6, second drive voltage V2 is obtained by applying electrical power from the second power source 480 to the second voltage regulator 485 at the second-voltage regulator input 486. The output of the second voltage reference 482 is applied to the second voltage regulator 485 at the second-voltage regulator control input 489 to set the value of the second drive voltage V2 at output of the second voltage source 160 which is connected to the second-switch input 136 of the second switch 135. Circuit feedback is provided by connecting second feedback resistor 483 between the second-voltage regulator output 487 and the second-voltage regulator control input 489.

The output of the first voltage source 115 which is at first drive voltage V1 is connected to the first-switch input 126; the first driver output 122 is connected to the first-switch control input 129; the first-switch output 127 is connected to the first-filter input 131; the output of second voltage source 160 which is at second drive voltage V2 is connected to the second-switch input 136; the second driver output 123 is connected to the second-switch control input 139; the second-switch output 137 is connected to the second-filter input 141; and the first-filter output 132 is connected to the second-filter output 142.

The electronic interface circuit 100 further comprises the detection circuit 150, wherein the detection circuit 150 comprises the differential receiver 155, and the detection voltage reference 165. The differential receiver 155 has the first receiver input 156, the second receiver input 157, and the receiver output 158. The first receiver input 156 is connected to first-filter output 132 and to the second-filter output 142, and the second receiver input 157 is connected to output of the detection voltage reference 165 which is at comparison voltage V3. The detection voltage reference 165 could be a digital to analogue converter (DAC) with its input set appropriately or the like. The receiver output 158 can be connected to the test system 10 electronics for the collection, comparison, and/or analysis of the test stimulus signal 102 at the stimulus-circuit output 112 or a response signal 103 received from the device under test 40 due to the test stimulus signal 102 received by the device under test 40 at another test pin 31 on the test head 30. In response to the response signal 103, the differential receiver 155 outputs a response output signal 104 at the receiver output 158.

In operation, a test signal indicated in FIG. 6 as drive signal 101 is applied to the stimulus circuit 110 at stimulus-circuit input 111 which is electrically the same as the driver input 121. In response to the drive signal 101, the driver circuit 120 turns on either the first field effect transistor 125 via a signal at the first-switch control input 129, or the driver circuit 120 turns on the second field effect transistor 135 via a signal at the second-switch control input 139.

If the first field effect transistor 125 is turned on and the second field effect transistor 135 is turned off, the output of the first voltage source 115 is electrically connected to the first-switch output 127 (the source of the MOSFET) which results in the potential of the output of the first voltage source 115 less any voltage drop across the first field effect transistor 125 appearing at the first-switch output 127. Again, the potential of the output of the first voltage source 115 is identified in FIG. 6 as first drive voltage V1. The first filter 130 filters the high-frequency components of the voltage waveform appearing at the first-switch output 127 to reduce/remove any ringing that might be present due to the switching on and off of the first field effect transistor 125. This filtered signal appears at the first-filter output 132 as test stimulus signal 102. The test stimulus signal 102 is then available for application to the device under test 40 via one of the test pins 31.

If the second field effect transistor 135 is turned on and the first field effect transistor 125 is turned off, a second drive voltage V2 less any voltage drop across the second field effect transistor 135 is connected to the second-switch output 137 (the drain of the MOSFET). The second filter 140 filters the high-frequency components of the voltage waveform appearing at the second-switch output 137 to reduce/remove any ringing that might be present due to the switching on and off of the second switch 135. This filtered signal appears at the second-filter output 142 as test stimulus signal 102. The test stimulus signal 102 is then available for application to the device under test 40 via one of the test pins 31.

One of the dangers in testing any device under test 40, as for example a printed circuit board or other device, is the possibility of a short circuit, for example a short to ground or a short to the power supply voltage. If, for example in FIGS. 3-6, a node attached to the stimulus-circuit output 112 is shorted to ground and a voltage is applied without current limiting, the drive circuitry can be destroyed. Representative embodiments disclosed herein provide a current limit to protect the drive circuitry. In particular, for the embodiment of FIG. 4 the first power source 470 limits the current that can be driven through the first field effect transistor 125 when turned on and the first filter 130 thus limiting the power that will be dissipated in these components and protecting them from destruction. Further, an appropriate design can ensure that the first voltage regulator 475 will build up heat at a faster rate that other system components. Once the first voltage regulator 475 hits its thermal trip temperature, the first voltage regulator 475 will turn itself off providing further protection to the remaining components of the drive circuitry.

Similar comments can be made for the second voltage source 160 in FIG. 6. In particular, the second power source 480 limits the current that can be driven through the second field effect transistor 135 and the second filter 140 thus limiting the power that will be dissipated in these components and protecting them from destruction. Further, an appropriate design can ensure that the second voltage regulator 485 will build up heat at a faster rate that other system components. Once the second voltage regulator 485 hits its thermal trip temperature, the second voltage regulator 485 will turn itself off providing further protection to the remaining components of the drive circuitry.

The second field effect transistor 135 of FIG. 4 when turned on can be protected by setting an allowable voltage at the stimulus-circuit output 112 above which the receiver 155 will detect that a short circuit or near short circuit exists at stimulus-circuit output 112 and will then turn off the drive electronics which could be, for example, the driver circuit 120 such that it would not drive the second field effect transistor 135 to its on state or will then disconnect the second field effect transistor 135 and/or the second ferrite bead 140 from the stimulus-circuit output 112.

Embodiments described herein are small enough that a sufficient number of them can be placed on a test head such that the tests to be performed on typical devices under test (loaded printed circuit boards) can be tested using a non-multiplexed test which is easier to understand and easier to program than is a multiplexed test. A non-multiplexed system reduces the time and training required for a programmer to become proficient in programming such a test system. Also, because multiplexed test systems are subject to resource conflicts, test programs must be written prior to the initiation of test fixture construction. Executing these two activities sequentially increases the time-to-test and thereby the time-to-volume production. With a non-multiplexed system, only the computer aided design (CAD) data for the device to be tested is necessary prior to fixture construction. As such, test programming and fixture construction can proceed in parallel. In addition, the embodiments disclosed herein provide increased drive capabilities over other non-multiplexed systems. Drive capabilities for non-multiplexed test systems have been increased over the capabilities previously available.

Further, embodiments described herein are capable of using low cost commodity components rather than custom or special purpose components. This capability means that the test system manufacturer can avoid the time and expense of developing custom integrated circuits for use on the test head of a test system. Using commodity integrated circuits reduces component lead times and inventory expenses. This results in an overall lowering of the total cost of the system and avoids non-recurring costs.

In a representative implementation, the output of the driver stage (the stimulus circuit 110) consists of low-cost power MOSFETs driven by a standard MOSFET drive chip. These parts are normally used in high-volume switching power supplies resulting in a high degree of toughness at low cost. Ferrite beads are used to round the corner of the resulting output signal. This wave shaping results in output signals that are well matched to the requirements of board test systems. The receiver is a low cost RS-485 chip. Again, a tough component is obtainable at a low cost. High speed comparators used in previous designs are not as tolerant of electrostatic discharge (ESD) and high voltages. Comparators place more emphasis on accuracy than is necessary for board tests. The drive level is set by changing the supply voltage for the upper output MOSFET. This voltage could be set, for example, by an 8-bit digital to analogue converter (DAC) driving a linear voltage regulator. This arrangement also provides current limiting. By using several different parts rather than a single custom integrated circuit. Parts constructed on different semiconductor technologies can be used which can result in higher performance.

Representative embodiments disclosed provide the capability of testing different logic families using the same components. If a particular logic family uses 3.3 volts, then the test system needs to drive the device under test to 3.3 volts, if on the other hand the logic family uses 2.5 volts then the test system needs to drive the device under test to 2.5 volts. The digital to analogue converters (DACs) in the first and second voltage sources 115,160 may be used as appropriate to set the “drive high/low drive” voltages. The use of the voltage regulator provides an inexpensive buffer that is thermally protected and works well for the present purposes.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. An electronic interface circuit, comprising:
a stimulus circuit comprising
a first voltage source,
a driver circuit having a first and a second driver outputs,
a first switch having a first-switch input, a first-switch output, and a first-switch control input,
a first filter having a first-filter input and a first-filter output,
a second switch having a second-switch input, a second-switch output, and a second-switch control input, and
a second filter having a second-filter input and a second-filter output, wherein output of the first voltage source is connected to the first-switch input, wherein the first driver output is connected to the first-switch control input, wherein the first-switch output is connected to the first-filter input, wherein the second-switch input is connected to a reference potential wherein the second driver output is connected to the second-switch control input, wherein the second-switch output is connected to the second-filter input, and wherein the first-filter output is connected to the second-filter output.

2. The electronic interface circuit as recited in claim 1, further comprising:
a detection circuit comprising
a differential receiver having a first receiver input and a second receiver input and
a detection voltage reference, wherein the first receiver input is connected to the first-filter output and to the second-filter output and wherein the second receiver input is connected to output of the detection voltage reference.

3. The electronic interface circuit as recited in claim 2, wherein the detection circuit is located on a test head of an electronic test system

4. The electronic interface circuit as recited in claim 1, wherein the stimulus circuit is located on a test head of an electronic test system

5. The electronic interface circuit as recited in claim 1, wherein the first and second switches are field effect transistors, wherein the gate of the first switch is first-switch control input, wherein the gate of the second switch is second-switch control input, wherein source and drain of the first switch are first-switch input and first-switch output as appropriate, and wherein source and drain of the second switch are second-switch input and second-switch output as appropriate.

6. The electronic interface circuit as recited in claim 1, wherein the first and second filters are ferrite beads.

7. The electronic interface circuit as recited in claim 1, wherein the first voltage source comprises a first electrical power source connected to the input of a first voltage regulator, a first voltage reference connected to a control input of the first voltage regulator, and an output of the first voltage regulator connected to the output of the first voltage source.

8. The electronic interface circuit as recited in claim 7, wherein the first voltage reference is a digital to analog converter.

9. The electronic interface circuit as recited in claim 7, wherein the first electrical power source and the first voltage regulator are fabricated as a single monolithic integrated circuit.

10. The electronic interface circuit as recited in claim 1, wherein the reference potential is ground potential.

11. An electronic interface circuit, comprising:
a stimulus circuit comprising
a first voltage source,
a second voltage source,
a driver circuit having a first and a second driver outputs,
a first switch having a first-switch input, a first-switch output, and a first-switch control input,
a first filter having a first-filter input and a first-filter output,
a second switch having a second-switch input, a second-switch output, and a second-switch control input, and
a second filter having a second-filter input and a second-filter output, wherein output of the first voltage source is connected to the first-switch input, wherein the first driver output is connected to the first-switch control input, wherein the first-switch output is connected to the first-filter input, wherein output of the second voltage source is connected to the second-switch input, wherein the second driver output is connected to the second-switch control input, wherein the second-switch output is connected to the second-filter input, and wherein the first-filter output is connected to the second-filter output.

12. The electronic interface circuit as recited in claim 11, further comprising:
a detection circuit comprising
a differential receiver having a first receiver input and a second receiver input and
a detection voltage reference, wherein first receiver input is connected to first-filter output and to second-filter output and wherein the second receiver input is connected to output of the detection voltage reference.

13. The electronic interface circuit as recited in claim 12, wherein the detection circuit is located on a test head of an electronic test system.

14. The electronic interface circuit as recited in claim 11, wherein the stimulus circuit is located on a test head of an electronic test system.

15. The electronic interface circuit as recited in claim 11, wherein the first and second switches are field effect transistors, wherein the gate of the first switch is first-switch control input, wherein the gate of the second switch is second-switch control input, wherein source and drain of the first switch are first-switch input and first-switch output as appropriate, and wherein source and drain of the second switch are second-switch input and second-switch output as appropriate.

16. The electronic interface circuit as recited in claim 11, wherein the first and second filters are ferrite beads.

17. The electronic interface circuit as recited in claim 11, wherein the first voltage source comprises a first electrical power source connected to the input of a first voltage regulator, a first voltage reference connected to a control input of the first voltage regulator, and an output of the first voltage regulator connected to the output of the first voltage source.

18. The electronic interface circuit as recited in claim 17, wherein the first voltage reference is a digital to analog converter.

19. The electronic interface circuit as recited in claim 11, wherein the second voltage source comprises a second electrical power source connected to the input of a second voltage regulator, a second voltage reference connected to a control input of the second voltage regulator, and an output of the second voltage regulator connected to the output of the second voltage source.

20. The electronic interface circuit as recited in claim 19, wherein the second voltage reference is a digital to analog converter.
